(19) United States
(12) Patent Application Publication
(10) Pub. No.: US 2005/0105636 A1
(43) Pub. Date: May 19, 2005

(54) Flow module and fuel cell having said flow module

(76) Inventors: Horst Belau, Langquaid (DE); Ulrich Wagner, Regensburg (DE)

Correspondence Address: MORRISON & FOERSTER LLP, 1650 TYSONS BOULEVARD, SUITE 300, MCLEAN, VA, 22102, US

(21) Appl. No.: 10/491,535

(22) PCT Filed: Oct. 2, 2002
(86) PCT No.: PCT/DE02/03739

(30) Foreign Application Priority Data
Oct. 4, 2001 (DE) 101 48 878.5

(51) Int. Cl. H04L 27/04

(52) U.S. Cl. 375/295

(57) ABSTRACT

The invention relates to flow module for a fuel cell comprising and polymer electrolyte membrane (PEM), said module supporting compensation of partial water vapor pressure using simple means thereby countering the drying of areas in the membrane even when the process gases fed to the fuel cell are only slightly humid or not humid at all. The flow module comprises at least one inlet (1) and at least one outlet (2) for a gas that is to be guided by means of an electrode of the fuel cell. The surface of the flow module that faces the electrode is structured in such a way that al least one channel (3) connecting the inlet (1) and the outlet (2) is formed between the flow module and the electrode. According to the invention, the at least one inlet (1) and the at least one outlet (2) are arranged and the at least one channel (3) is guided in such a way that the segments of the channel having a higher relative humidity are arranged in the vicinity of the segments of the channel having a lower relative humidity so that the humidity gradient on the PEM is balanced out.

### CLAIM FOR PRIORITY

This application is a national stage of PCT/DE02/03739, which was published in the German language on Apr. 17, 2003, and which claims the benefit of priority to German Application No. 101 48 878.5, filed on Oct. 4, 2001.

### TECHNICAL FIELD OF THE INVENTION

The invention relates to a system and method for the transmission of digital data.

### BACKGROUND OF THE INVENTION

Systems and methods according to the generic type are, for example, used for the transmission of digital graphics data. In this case, camera systems are provided as satellite systems and the graphics data is transmitted from the individual camera systems via cables to a central evaluation unit. It is often desirable to transmit data over a great distance, for example over several meters. Standards, such as LVDS (Low Voltage Differential Signaling) have been developed for this purpose. A disadvantage of such systems is that a large number of cables are necessary because one conductor pair is required per channel.

To overcome these disadvantages, systems, such as circuit modules, have been developed that multiplex the data to be transmitted and transmit it serially via an LVDS conductor pair to the evaluation unit. After receipt of the data it is converted back to parallel data in the evaluation unit and the transmitter bit timing is reconstructed. Without further processing, the described systems have the property that each individual satellite system works with its own timing. The evaluation unit also operates with its own timing. However, to be able to process graphics data, for example from several cameras simultaneously, in the evaluation unit, synchronization is necessary. This means that the timings involved must be identical and constant with regard to their frequency and phase angle.

Because such synchronization is not easily accomplished with regard to the timing of the satellite systems and of the evaluation unit, on systems in the prior art the satellite systems each operate using their o1wn timing, that is generally asynchronous to the timing of the evaluation unit. To balance out the different phases of the signals read from the evaluation unit, memory modules (e.g. FIFO modules) are used in the evaluation unit. These can partially buffer store the transmitted data and match it to the timing of the evaluation unit. A memory module of this kind is, however, considerably expensive to provide.

### SUMMARY OF THE INVENTION

The invention relates to a system and method for the transmission of digital data, with an evaluation unit, several satellite systems connected to the evaluation unit for the transmission of data and a serial interface between the evaluation unit and the satellite systems.

The invention also refers to a method for the transmission of digital data from several satellite systems to an evaluation unit that is connected to the satellite systems, with the data being transmitted via a serial interface from the satellite systems to the evaluation unit.

The invention also refers to the use of systems for the transmission of digital data.

The invention overcomes the disadvantages of the prior art, whereby in particular it should be possible to use evaluation units without the cost-intensive memory modules for the buffer storage of data.

In one embodiment of the invention, there is a system according to the generic type in that synchronization units for the synchronization of transmitter bit timings of the data transmissions from the satellite systems to the evaluation unit are provided, that a synchronization unit is allocated to each satellite system and that the synchronization units individually synchronize the transmitter bit timings of the satellite systems received by the evaluation unit, on the basis of a system clock of the evaluation unit. Without the use of this invention, synchronization of satellite systems with each other and of the satellite systems with the evaluation unit is a difficult undertaking. In the simplest case, a synchronization would be undertaken in that the evaluation unit would transmit its timing to the satellite systems and operate this with the same timing. A solution of this kind is, however, subject to substantial problems. The system clock of the evaluation unit has to be transmitted over a certain cable run and via transmitting and receiving modules to the satellite systems. Because of tolerances, particularly component tolerances, and also because of component aging, cable lengths and environmental conditions, such as temperature, phase shifts reoccur that sometimes can be in the order of one clock pulse period. Furthermore, the data transmitted by the satellite systems to the evaluation unit, i.e. for example the graphics data, can also be subject to additional phase shifts because of the transmission via the cable run. The result is an undefined phase shift that can lead to failure of the system. This invention rectifies all these problems. It is provided that a synchronization unit is allocated to each satellite system, so that an individual synchronization of the satellite systems on the basis of the system clock of the evaluation unit can take place. This system differs from the mere transmission of the system clock to the satellite systems in that the transmitter bit timings of the satellite systems received by the evaluation unit are individually synchronized. Therefore not only is a system clock transmitted as a whole to the satellite systems but rather an individual synchronization of the satellite systems is achieved on the basis of the actual timing received.

The system builds on the invention in an advantageous manner in that the synchronization units are spatially arranged either at or in the evaluation unit. In this way, the synchronization takes place in the spatial area in which, on the one hand, the system clock is available and, on the other hand, the transmitter bit timings of the satellite systems received by the evaluation unit are present. Therefore, the timing decisive for the construction of the parallel data is compared directly with the system clock.

Also in the context of this invention, it can be advantageously provided that each synchronization unit receives the timing, received from the evaluation unit, of the satellite system allocated to it as an input signal, that each synchronization unit receives the system clock of the evaluation unit as an output signal and that each synchronization unit outputs an output signal to influence the phase angle of the transmitter bit timing of the satellite system allocated to it. In this way, the output signal can provide the phase angle individually for each satellite system relative to the transmitter bit timing received by the evaluation unit and relative to the system clock.

In another embodiment of the invention, the evaluation unit for each satellite system has a transmitter, in that the evaluation unit for each satellite system has a receiver, in that each satellite system has a receiver that is connected to a transmitter of the evaluation unit and in that each satellite system has a transmitter connected to a receiver of the evaluation unit, and in that the data to be evaluated is transmitted through the connection between the transmitter of a satellite system and the allocated receiver of the evaluation unit and that signals for synchronizing the transmitter bit timings of the satellite system are transmitted via the connection between a transmitter of the evaluation unit and the receiver of the allocated satellite system. In this way, the system data can be transmitted from the satellite system to the evaluation unit. Unaffected by this, the signals required for synchronization can be transmitted via a further connection between the evaluation unit and the satellite systems.

In this connection, it should be noted that it is particularly advantageous for each satellite system to be connected by two pairs of conductors to the evaluation unit. One conductor pair is provided for transmitting the signals required for synchronization. The other conductor pair is used to transmit data. LVDS (Low Voltage Differential Signaling) is, for example, used as a connecting technique, thus enabling the number of conductors to be reduced by the use of a serial interface. The reconstruction of serial data to form parallel data takes place without difficulty due to the synchronization of the individual satellite systems with the system clock.

Furthermore, it is also particularly advantageous that control signals for influencing the functions of satellite systems are transmitted via the connection between a transmitter of the evaluation unit and the receiver of the allocated satellite system. The connections for transmission of the signals necessary for synchronization can therefore be transmitted over the same connecting lines as the control signals, for example to adjust the exposure time of cameras. These control signals need not necessarily be transmitted synchronized because the data rate of the control signals is substantially lower than those of the transmitted data. For example, control signals with rates of 200 kHz can be transmitted, whereas data rates of between 10 MHz and 80 MHz are possible.

It is particularly preferable for the evaluation unit to have a microcontroller. Such a microcontroller processes the received data, with the processing being based on the system clock. This system clock is also used for synchronizing the satellite systems.

In still another embodiment of the invention, the synchronization units are realized as PLL (Phase Locked Loop) circuits. In PLL circuits, the transmitter bit timings of the satellite systems are interlocked with the system clock relative to the timing received by the evaluation unit. Thus, individual synchronization of the satellite systems with a common clock can be advantageously achieved.

In yet another embodiment of the invention, the evaluation unit has an FPGA (Field Programmable Gate Array) and that the FPGA has DLL (Delay Locked Loop) circuits that are used as synchronization units. FPGA circuits of this type frequently have integrated interlocking circuits, so that synchronization can be achieved without the need for additional components, by using these DLL circuits.

In a preferred embodiment of the invention, the satellite systems are camera systems. Synchronization of the large amount of data occurring for transmission is particularly useful for graphics data transmission.

This invention also reveals its advantages in this case if the satellite systems are sensor systems. Numerous different sensors are conceivable that supply their information to a central evaluation unit. The advantages of this invention then come into play, particularly where a synchronized reception of the data provided by the sensors is desirable.

Furthermore, it can be advantageously provided that in addition to the system clock of the evaluation unit, other timing information of the satellite systems can also be taken into account. This ensures that the synchronization can also take place relative to clock pulses that determine the graphics data processing of the cameras. Additional synchronization information is thus received and it can be ensured that no unwanted shift by one or more clock pulses occurs during the graphics data reception from the individual camera systems.

In another embodiment of the invention, there is a method in which the transmitter bit timings of the data transmissions are synchronized with the evaluation unit and the transmitter bit timings of the satellite systems are individually synchronized by synchronization units on the basis of a system clock of the evaluation unit. The advantages of the system in accordance with the invention can also be utilized in this way as part of the method. This also applies to the preferred forms of embodiment of the method in accordance with the invention described in the following.

For example, the method can be further developed in an advantageous manner in that the synchronization takes place spatially at or in the evaluation unit.

Also, in another embodiment of the method it is designed so that each synchronization unit receives the timing of the satellite system allocated to it, received from the evaluation unit, as an input signal, that each synchronization unit receives the system clock of the evaluation unit as an input signal and that each synchronization unit outputs an output signal to influence the phase angle of the transmitter bit timing of the satellite system allocated to it.

Furthermore, as part of the method in accordance with the invention, it can be provided that the evaluation unit for each satellite system has a transmitter, that the evaluation unit for each satellite system has a receiver, that each satellite system has a receiver connected to the evaluation unit, that each satellite system has a transmitter connected to a receiver of the evaluation unit, that data to be evaluated is transmitted via the connection between the transmitter of a satellite system and the allocated receiver of the evaluation unit and that signals for synchronizing the transmitter bit timings of the satellite system are transmitted via the connection between a transmitter of the evaluation unit and the receiver of the allocated satellite system.

The method is further advantageous in that control signals to influence functions of satellite systems are transmitted via the connection between a transmitter of the evaluation unit and the receiver of the allocated satellite system.

It is particularly advantageous if the data is evaluated by a microcontroller.

It is also particularly useful if PLL (Phase Locked Loop) circuits are used for synchronization.

In a preferred embodiment of the method in accordance with the invention, it is provided that the evaluation unit has an FGPA (Field Programmable Gate Array) and that the FGPA has DLL (Delay Locked Loop) circuits that are used as synchronization units.

The method in accordance with the invention is also advantageously further developed in that further timing information of the satellite systems is taken into account in addition to the system clock of the evaluation unit.

The method in accordance with the invention also refers to the use of a system in accordance with the invention for monitoring dead angles on a vehicle. This can, for example, be accomplished in that a camera is fitted in both outside mirrors. The cameras are supplied via an LVDS conductor pair with a clock signal of appropriately matched phase and with the configuration signals. Then, for example, 8-bit gray values can be transmitted via a second LVDS conductor pair.

The invention also includes the use of a system in accordance with the invention for detection of seat positions in a vehicle.

Such seat position detection can also advantageously take place by means of two or more cameras, so that the information can be advantageously converted by an evaluation unit.

Furthermore, the invention refers to the use of a system in accordance with the invention for track detection.

It can also be provided that the system in accordance with the invention is used as part of a pre-crash sensor system. By means of a sensor system of this kind, graphics data, or also for example radar data, can be evaluated.

The invention rests on the knowledge that, based on the individual synchronization of the individual satellite systems with regard to the system clock of an evaluation unit, it is possible to configure the connected satellites through a serial interface. SPI or I²C interfaces can, for example, be used for this purpose. It is possible that satellites supply data to the evaluation unit in sync with the clock of the evaluation unit, which means that particularly expensive FIFO buffer storage units are unnecessary. It is possible to connect each satellite system to the evaluation unit through two conductor pairs, with it being possible, for example, to use conductor pairs up to 10 m long by using the LVDS conductor technique.

### BRIEF DESCRIPTION OF THE DRAWINGS

The invention is now further explained, by reference to the accompanying drawing, and using a preferred form of embodiment as an example.

The drawing is as follows.

FIG. 1 A schematic block diagram of a system in accordance with the invention.

### DETAILED DESCRIPTION OF THE INVENTION

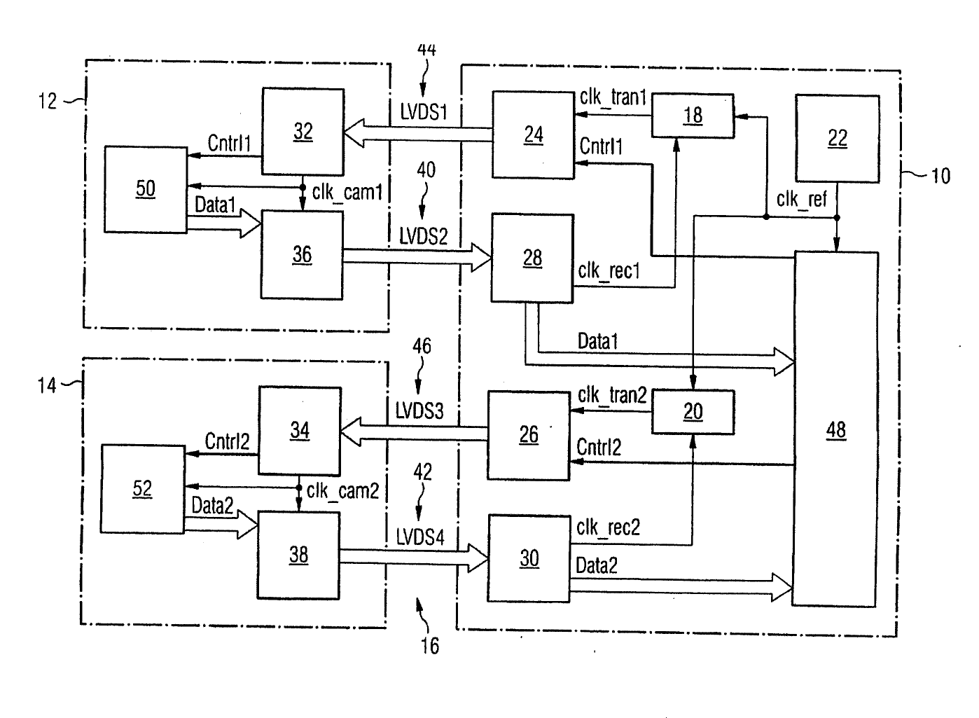

FIG. 1 shows a schematic block diagram of a system in accordance with the invention. This is, for example, described using the kind of system where the satellite systems are camera systems, where graphics data, provided by the camera systems 12, 14, is serially read by an evaluation unit 10. The first camera system 12 has a camera 50, an LVDS receiver 32 and an LVDS transmitter 36. Similarly, the second camera system 14 has a camera 52, an LVDS receiver 34 and an LVDS transmitter 38. To communicate with the named receivers 32, 34 and transmitters 36, 38, the evaluation unit 10 is provided with an LVDS transmitter 24 an LVDS receiver 28 for communication with the first camera system 12, and with an LVDS transmitter 26 and LVDS receiver 30 for communication with the second camera system 14. An interface 16 is made available by means of the aforementioned transmitters and receivers. Data transmission Data1 from the first camera system 12 to the evaluation unit 10 is via an LVDS conductor pair 40. Data transmission Data2 from the second camera system 14 to the evaluation unit 10 takes place via a further LVDS conductor pair 42. By means of a further LVDS conductor pair 44, control signals Cntr11 are transmitted from the evaluation unit 10 to the first camera system 12. Control signals Cntrl2 are transmitted from the evaluation unit 10 to the second camera system 14 through a further LVDS conductor pair 46.

In accordance with the invention, it is provided that furthermore a clock signal clk_tran1 is transmitted via the LVDS conductor pair 44 to the first camera system 12. Similarly, a clock signal clk_tran2 is transmitted via LVDS conductor pair 46 to the second camera system. These clock signals clk_tran1, clk_tran2 are the output signals of two synchronization units 18, 20, with a first synchronization unit 18 being allocated to the first camera system 12 and a second synchronization unit 20 being assigned to the second camera system 14. One of the clock signals clk_rec1 received by the evaluation unit 10 is transmitted from the receiver 28 to the synchronization unit 18. The synchronization unit 18 also receives system clock 22 as signal clk_ref. In this way, the synchronization unit 18 can produce an appropriate phase matching of the clock signal clk_rec1 received from the evaluation unit 10 to the system clock clk_ref. Similarly, the evaluation unit 10 receives a clock signal clk_rec2 that is passed on from the receiver 30 to the synchronization unit 20. The synchronization unit 20 also receives the system clock clk_ref. Thus, the clock signal clk_rec2 can also be matched to the system clock clk_ref by an appropriate phase shift. The synchronization units 18, 20 are preferably realized as PLL circuits, so that the phases of the signals received by the evaluation unit 10 can be interlocked with the system clock.

In this way, it is possible to use a serial interface 16 because in-phase systems communicate with each other and the serial data can thus be reliably converted to parallel data in the microcontroller 48, without which an expensive buffer storage would be necessary.

The features of the invention disclosed in this description, in the drawings and in the claims, can be essential both individually and in any combination for the realization of the invention.

1. System A system for the transmission of digital data comprising:
an evaluation unit;
plurality of satellite systems that are connected to the evaluation unit for transmission of data; and
serial interface between the evaluation unit and the satellite systems, wherein
synchronization units are provided for synchronizing transmitter bit timings of the data transmission of the plurality of satellite systems to the evaluation unit,
a synchronization unit is allocated to each satellite system, and
the transmitter bit timings of the plurality of satellite systems received by the synchronization units are individually synchronized based on a system clock of the evaluation unit.

2. The system in accordance with claim 1, wherein the synchronization units are spatially arranged at or in the evaluation unit.

3. The system in accordance with claim 1, wherein
each synchronization unit receives the clock signal, received from the evaluation unit, of the satellite system allocated to it as an input signal,
each synchronization unit receives the system clock of the evaluation unit as an input signal, and
each synchronization unit outputs an output signal for influencing a phase angle of the transmitter bit timing of the satellite system allocated thereto.

4. The system in accordance with claim 1, wherein
the evaluation unit has a transmitter for each satellite system,
the evaluation unit has a receiver for each satellite system,
each satellite system has a receiver that is connected to a transmitter of the evaluation unit,
each satellite system has a transmitter that is connected to a receiver of the evaluation unit,
data to be evaluated is transmitted via a connection between the transmitter of a satellite system and the allocated receiver of the evaluation unit, and
signals for synchronization of the transmitter bit timings of the satellite systems are transmitted via the connection between a transmitter of the evaluation unit and the receiver of the allocated satellite system.

5. The system in accordance with claim 1, wherein each satellite system is connected to the evaluation unit by means of two pairs of conductors.

6. The system in accordance with claim 1, wherein control signals for influencing functions of the satellite systems are transmitted via the connection between a transmitter of the evaluation unit and a receiver of the allocated satellite system.

7. The system in accordance with claim 1, wherein the evaluation unit has a microcontroller.

8. The system in accordance with claim 1, wherein the synchronization units are Phase Locked Loop circuits.

9. The system in accordance with claim 1, wherein
the evaluation unit has a Field Programmable Gate Array, and
the Field Programmable Gate Array has Delay Locked Loop circuits that are used as synchronization unit.

10. The system in accordance with claim 1, wherein the satellite systems are camera systems.

11. The system in accordance with claim 1, wherein the satellite systems are sensor systems.

12. The system in accordance with claim 1, wherein in addition to the system clock of the evaluation unit, further timing information of the satellite systems is taken into account.

13. A method for transmission of digital data of satellite systems to an evaluation unit configured for connection to the satellite systems, with the digital data being transmitted via a serial interface from the satellite systems to the evaluation unit, comprising:
synchronizing the transmitter bit timings of the data transmission from the satellite systems to the evaluation unit; and
individually synchronizing the transmitter bit timings of the satellite systems by synchronization units based on a system clock of the evaluation unit.

14. The method in accordance with claim 13, wherein the synchronization takes place spatially at or in the evaluation unit.

15. The method in accordance with claim 13, wherein each synchronization unit
receives the clock signal, received from the evaluation unit, of the satellite system allocated thereto, as an input signal,
receives the system clock of the evaluation unit as an input signal, and
outputs an output signal for influencing a phase angle of the transmitter bit timing of the satellite system allocated thereto.

16. The method in accordance with claim 13, wherein
the evaluation unit has a transmitter for each satellite system,
the evaluation unit has a receiver for each satellite system,
each satellite system has a receiver that is connected to a transmitter of the evaluation unit,
each satellite system has a transmitter that is connected to a receiver of the evaluation unit,
data to be evaluated is transmitted via the connection between the transmitter of a satellite system and the allocated receiver of the evaluation unit and
signals for synchronization of the transmitter bit timings of the satellite system are transmitted via a connection between a transmitter of the evaluation unit and the receiver of the allocated satellite system.

17. The method in accordance with claim 13, wherein control signals for influencing functions of the satellite systems are transmitted via a connection between a transmitter of the evaluation unit and a receiver of the allocated satellite system.

18. The method in accordance with claim 13, wherein the data is evaluated by a microcontroller.

19. The method in accordance with claim 13, wherein Phase Locked Loop circuits are used for synchronization.

20. The method in accordance with claim 13, wherein
the evaluation unit has a Field Programmable Gate Array, and
the Field Programmable Gate Array has Delay Locked Loop circuits that are used as synchronization units.

21. The method in accordance with claim 13, wherein in addition to the system clock of the evaluation unit, further timing information of the satellite systems is taken into account.

22. Use of a system in accordance with claim 1, for monitoring dead angles on a vehicle.

23. Use of a system in accordance with claim 1, for detection of seat positions in a vehicle.

24. Use of a system in accordance with claim 1, for track detection.

25. Use of system in accordance with claim 1, as part of a pre-crash sensor system.
